(19) United States
(12) Patent Application Publication
(10) Pub. No.: US 2006/0199495 A1
(43) Pub. Date: Sep. 7, 2006

(54) Receiving device

(75) Inventor: Shoichi Yamaguchi, Minamiazumi-gun, Nagano (JP)

Correspondence Address: BLANK ROME LLP, 600 NEW HAMPSHIRE AVENUE, N.W., WASHINGTON, DC, 20037, US

(73) Assignee: GAC Corporation, Minamiazumi-gun, Nagano (JP)

(21) Appl. No.: 10/535,144

(22) PCT Filed: Jun. 25, 2004
(86) PCT No.: PCT/JP04/09025

§ 371 Date: Feb. 24, 2006

(30) Foreign Application Priority Data
Jun. 27, 2003 (JP) 2003-185429

(51) Int. Cl. A47J 47/00

(52) U.S. Cl. 454/173

(57) ABSTRACT

There is provided a storage apparatus including a shelf for displaying products, a first out-of-shelf supply duct that supplies first conditioning air adjusted to a first condition for controlling environmental conditions in a periphery of the products, and a second out-of-shelf supply duct that supplies second conditioning air adjusted to a second condition that differs to the first condition. The shelf includes: a first connection port that is connected to the first out-of-shelf supply duct; a second connection port that is connected to the second out-of-shelf supply duct; an opening adjusting means that adjusts respective openings of the first connection port and the second connection port to the above supply ducts, and a shelf supply duct for mixing the first conditioning air supplied from the first connection port and the second conditioning air supplied from the second connection port and blowing out from air outlets disposed on the shelf. It is therefore possible to provide a storage apparatus where, for each self, the conditions of the conditioning air can be freely set and the conditioning air is supplied to products.

### TECHNICAL FIELD

The present invention relates to a storage apparatus such as a showcase that can store and display products (commercial products) at their peculiar environmental conditions in a supermarket, a convenience store, or the like.

### BACKGROUND ART

An open showcase that is set up in a supermarket or the like to show and display products is known. In an open showcase, an air curtain is formed at the front surface of a case so that products such as canned drinks can be chilled. In a showcase disclosed by Japanese Laid-Open Patent Publication No. S55-165468 (hereinafter S55-165468), cold air is blown out downward from the front ends of shelves, with the cold air being sucked in from the front end of a lower shelf so that individual air curtains are formed in each space that is partitioned by the shelves.

### DISCLOSURE OF THE INVENTION

When many types of products are displayed or shown in a showcase, there are cases where environmental conditions such as temperature should be changed for each type of products. In a showcase shown in the prior art in the S55-165468 that is covered with a single air curtain is characterized by the upper shelves that are close to the cold air outlet being well chilled but the lower shelves being difficult to chill. It is therefore preferable to place products for which chilling is desired on the upper shelves and products for which chilling is not desired on the lower shelves. However, since the difference in temperature is merely one of the upper shelves being well chilled and the lower shelves being difficult to chill, it is not possible to actively control the temperature.

The technology disclosed in the S55-165468 eradicates the difference in temperature in that the upper shelves are well chilled and the lower shelves are difficult to chill as described above by blowing out cold air downward from the front ends of the upper shelves and sucking in the cold air from the front ends of the lower shelves, thereby making the distances covered by the air curtains shorter. Accordingly, the temperature inside the showcase becomes constant, so that it is still not possible to store various types of products at different temperatures.

It is an object of the present invention to provide a storage apparatus where a storage space for a showcase can be divided into a plurality of spaces with environmental conditions, such as temperature and humidity, being freely set. It is an object to provide a storage apparatus where environments with different temperatures, such as a chilled region, normal-temperature region, and a heated region, can be flexibly formed in a single storage apparatus.

In the present invention, the above problem is solved by independently guiding a plurality of types of conditioning air with different states or conditions, such as temperature, to shelves used to display products. A storage apparatus according to the present invention includes a shelf for displaying products, a first out-of-shelf supply duct that, for controlling environmental conditions in a periphery of the products, supplies first conditioning air adjusted to a first condition, and a second out-of-shelf supply duct that supplies second conditioning air adjusted to a second condition that differs to the first condition. The shelf for displaying products includes: a first connection port that is connected to the first out-of-shelf supply duct; a second connection port that is connected to the second out-of-shelf supply duct; an opening adjusting means that adjusts an opening of the first connection port to the first out-of-shelf supply duct and an opening of the second connection port to the second out-of-shelf supply duct, respectively; and a shelf supply duct for blowing out at least one of the first conditioning air supplied from the first connection port and the second conditioning air supplied from the second connection port from air outlets disposed at least one of above and below the shelf.

In the storage apparatus according to the present invention, the first conditioning air and the second conditioning air are supplied via the shelf. Accordingly, the respective flow amounts of the first conditioning air and the second conditioning air blown out from the shelf can be controlled by the opening adjusting means provided on the shelf. This means that, from each shelf, air with different conditions can be blown out and supplied to the periphery of the products, so that the different environmental conditions for displaying products can be flexibly set in the storage sections of the storage apparatus on a shelf-by-shelf basis. In a storage space, if a chilled region and a heated region are made simply blowing out cold air and hot air from out-of-shelf ducts to the respective regions, a region where the cold air and hot air are mixed will be made and such an unintended temperature region between a heated region and a chilled region would greatly reduce the usage efficiency of the storage space (preservation space) inside the storage apparatus. On the other hand, by attaching shelves and blowing out conditioning air controlled to an appropriate temperature, such as cold air or hot air, from the shelves, it is possible to partition the storage space of the storage apparatus into different temperature regions in shelf units. When the conditioning air with different temperatures is supplied on the above and below a shelf, there is little possibility of the conditioning air being mixed, so that the storage space in which the shelf is set can be used efficiently.

One method of setting the temperature of the air blown out onto products is preparing air with a desired temperature by mixing cold air and hot air. If cold air and hot air were supplied to the storage space separately, it may be possible to mix the cold air and the hot air in some region inside the storage space, and the desired temperature may possibly be achieved at the region. However, there is a difference in temperature between at least the supply openings of the cold air and the hot air, so that it is not possible to place products that need to be kept at a desired temperature at such positions. It would be possible to provide chambers that mix the cold air and the hot air at every air outlets on the duct side. However, space for providing the chambers would become necessary. When it is not known in advance how the storage space will be partitioned and how the temperature will be controlled, it will be necessary to connect chambers to all of the air outlets in advance.

According to the present invention, since the first conditioning air and the second conditioning air are blown out via a shelf, the inside of the shelf, that is, the shelf supply duct can be used as a chamber for mixing and blowing out conditioning air with different conditions. Conditioning air that has been mixed to match a desired temperature and/or other conditions can be blown out by the shelf to products positioned above and/or below the shelf. That is, by mixing the first conditioning air supplied from the first connection port and the second conditioning air supplied from the second connection port in the shelf supply duct, even if chambers are not separately provided, it will be possible to blow out air with desired conditions in shelf units, so that spaces for providing chambers on the duct side is not required.

In addition, since the shelves that partition the storage space themselves are used as a means for producing air of the desired conditions, it is not necessary to determine in advance how the storage space should be divided and to provide chambers and the like, which means that the storage space can be used efficiently and flexibly. Since the mixing proportions of the first conditioning air and the second conditioning air can be flexibly set by the opening adjusting means, it is possible to freely produce air with various different temperature conditions on a shelf basis. The shelf supply duct can be disposed on the upper surface or rear surface of the shelf, or can be enclosed within the shelf.

When a plurality of types of conditioning air are mixed and blown out from the shelf, the first connection port and the second connection port should preferably be disposed so as to not coincide (overlap) in a left-right direction of the shelf, and the shelf supply duct should preferably include a mixing part that extends in the left-right direction of the shelf so as to connect the first connection port and the second connection port and a supply part that extends from the mixing part in a front-rear direction of the shelf. The supply part is connected to the air outlets, and a cross-sectional area of the supply part is smaller than that of the mixing part. The out-of-shelf supply ducts can be arranged separately in the front-rear of the shelves, but such an arrangement of the ducts obstructs access to the products on the shelves. The out-of-shelf supply ducts should preferably be arranged at ends in the left-right direction of the shelves or in parallel in the left-right on the side (wall or base side) where the shelf is attached. If the first and second ports are disposed in the left-right direction corresponding to this duct arrangement, the mixing part will extend in the left-right direction, so that the mixing part will be suited to mixing conditioning air supplied from the respective out-of-shelf supply ducts. By providing the supply part that extends in the front-rear direction from the mixing part with a smaller cross-sectional area than that of the mixing part, conditioning air that has been mixed (adjusted) can be outputted substantially and uniformly to the entire shelf and in particular the entire surface of the shelf on which products are placed. By making the cross-sectional area of the supply part sufficiently small relative to the mixing part, it is possible to reduce the speed of air flow in the mixing part and to increase the static pressure, so that different conditioning air can be sufficiently mixed in the mixing part and conditioning air of uniformly mixed is supplied from the shelf.

The mixing part should preferably be disposed on a base end side of the shelf. The base end side is a side where the shelf is attached to at least one of the first out-of-shelf supply duct, the second out-of-shelf supply duct, and a housing that forms a storage space in which the shelf is disposed. In the shelf where the mixing part is disposed on the base end side, a shape where the base end side is thick and the front end side is thin is applied. With this design, it is easy to strengthen the part that is fixed to or detachably attached to at least one of the out-of-shelf supply ducts and the housing that forms the storage space. In the shelf where the mixing part is disposed on the base end side, the plurality of types of conditioning air supplied to the shelf is mixed at the shelf entrance to produce air of desired conditions and the mixed air is supplied to the entire surface by the supply part.

It is possible for the shelf to be provided with a shelf discharge duct and a third connection port that connects the shelf discharge duct to a out-of-shelf discharge duct. Since discharge is also carried out via the shelf, the construction of the non-shelf part of the storage apparatus can be made even simpler. In the storage apparatus, by arranging the out-of-shelf discharge duct in parallel with the first out-of-shelf supply duct and the second out-of-shelf supply duct, the duct layout is simplified. In this case, the first connection port, the second connection port, and the third connection port can be disposed in a line in the left-right direction on the shelf. In view of the balance of discharging, the third connection port should preferably be disposed between the first connection port and the second connection port. By disposing the shelf discharge duct along the base end, the cross-sectional area of the shelf at the base end side is increased, resulting in increased strength.

By providing, on a plurality of shelves, a means for detachable attachment on at least one of the first out-of-shelf supply duct, the second out-of-shelf supply duct, and a housing that forms a storage space in which the shelves are disposed, it becomes possible to freely set the sizes of the spaces produced by partitioning with the shelves in accordance with the heights and/or amounts of products. In this invention, such spaces can be kept at desired conditions by the conditioning air blown out to the periphery of products from the shelves. It is preferable to provide dampers on connection ports of the first out-of-shelf supply duct and the second out-of-shelf supply duct and where, by having the dampers automatically close when a shelf is detached, conditioning air is blown out automatically via shelves only when the shelves are attached. By this mechanism, it is possible to reduce the burden of sealing every connection port of the supply ducts with jigs such as flanges.

The sensor detects whether the shelf is mounted or not, and the connection ports on the out-of-shelf ducts can be open and close by the dampers that are automatically controlled. The opening adjusting means of the shelf may incorporate dampers that control the opening of the first and second connection ports of the shelf in order to adjust the degree of opening between the first connection port and the first out-of-shelf supply duct and the degree of opening between the second connection port and the second out-of-shelf supply duct, respectively. When dampers are provided on the out-of-shelf supply ducts, by adjusting the degree of openings of such dampers using the opening adjusting means on the shelf side, dampers on the shelf side become unnecessary, and it is also possible to automatically close the dampers on the supply duct side by detaching the shelf.

In the present invention, the shelf can include a first shelf supply duct that outputs, from an upper surface of the shelf, one of the first conditioning air supplied from the first connection port and the second conditioning air supplied from the second connection port and a second supply duct that outputs, from a lower surface of the shelf, the other of the first conditioning air and the second conditioning air. According to this shelf, by a single shelf, conditioning air of different conditions, for example, hot air and cold air can be supplied above and below the shelf respectively.

### BRIEF DESCRIPTION OF THE DRAWINGS

FIG. 1 is a vertical cross-sectional view schematically showing a storage apparatus according to the present invention.

FIG. 2 is a perspective view that schematically shows the interior of the storage apparatus shown in FIG. 1 through the housing.

FIG. 3 is a perspective view showing a display shelf.

FIG. 4 is three cross-sectional views showing the construction of the display shelf, with FIG. 4A being a cross-sectional view of a part including a return port (a third connection port), FIG. 4B being a cross-sectional view of a part including a hot air intake port (a second connection port), and FIG. 4C being a cross-sectional view of a part including a cold air intake port (a first connection port).

FIG. 5 shows a damper opening control apparatus provided on the display shelf.

FIG. 6 shows how a temperature in a range from heating to chilling is realized by controlling the opening of the dampers.

FIG. 7 is a perspective view showing the external appearance of a display shelf that blows out hot air from an upper surface and cold air from a rear surface.

FIG. 8 is two cross-sectional views showing the construction of the display shelf, with FIG. 8A being a cross-sectional view of a part including a cold air intake port (a first connection port) and FIG. 8B being a cross-sectional view of a part including a hot air intake port (a second connection port).

FIG. 9 is a perspective view showing a different storage apparatus.

### BEST MODE FOR CARRYING OUT THE INVENTION

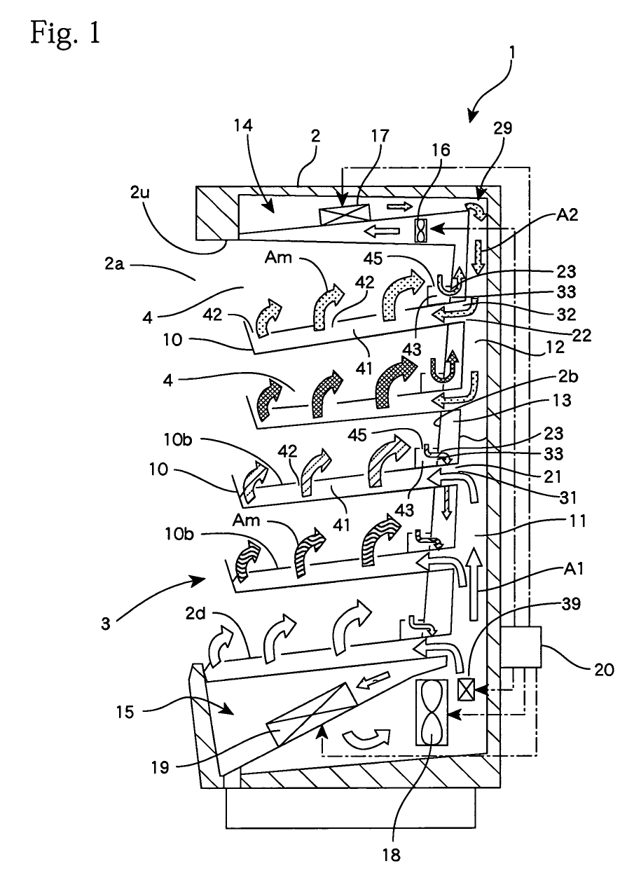

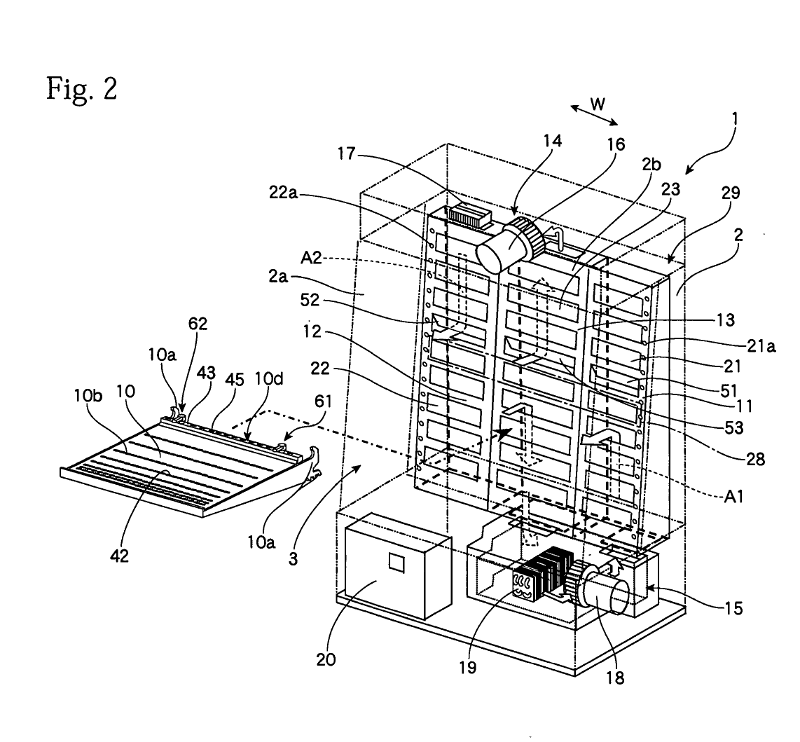

The present invention is described in more detail below with reference to the drawings. FIG. 1 is a cross-sectional view schematically showing the construction of a storage apparatus of the present invention. FIG. 2 is a perspective view that schematically shows the interior of the storage apparatus 1 through a housing 2. FIG. 2 shows a state where a shelf on which products (commercial products) are displayed has been removed. The storage apparatus 1 includes an insulated housing 2, that is a display case, and the housing 2 forms a storage space 3 in which shelves are disposed. A plurality of display shelves 10 can be disposed in the storage space 3 at appropriate intervals in an up-down direction, with such display shelves 10 partitioning the storage space 3 in the up-down direction. The respective zones 4 partitioned by the display shelves 10 is a unit for supplying or discharging air, which is required to maintain the quality and the like of products, displayed on the shelves 10.

In FIG. 1, the storage space 3 is compartmentalized by four display shelves 10 arranged vertically to form five zones 4 in the up-down direction. The uppermost zone 4 is the space between the roof 2u of the display case 2 and a shelf 10, while the second to fourth zones 4 from the top are spaces with shelves 10 above and below and the lowermost zone 4 is the space between a shelf 10 and a base 2d of the display case 2. In this storage apparatus 1, conditioning air Am is supplied via the display shelves 10, circulates inside the zones 4, and is sucked in and exhausted via the display shelves 10. Accordingly, independent air cycles are formed on a display shelf basis. This means that environmental conditions including temperature, humidity, and the like can be set and maintained on a display shelf basis for the products displayed on the display shelves 10. Although the storage apparatus 1 is an open showcase where the front surface 2a of the display case 2 is open, the internal storage space 3 is divided into a plurality of spaces where different conditions can be set.

The storage apparatus 1 includes a first out-of-shelf supply duct 11 for supplying conditioning air (first conditioning air) A1 at a low temperature (a first condition), a second out-of-shelf supply duct 12 for supplying conditioning air (second conditioning air) A2 at a high temperature (a second condition), and a out-of-shelf discharge duct 13 for exiting air. An interior of a rear wall 2b of the case 2 is a duct space 29. The first out-of-shelf supply duct 11, the second out-of-shelf supply duct 12, and the out-of-shelf discharge duct 13 are disposed in parallel so as to extend in the up-down direction in the duct space 29. It should be noted that to make it easy to understand the fluids and the like that flow inside, in FIG. 1 the out-of-shelf supply ducts 11, 12 and the out-of-shelf discharge duct 13 are arranged in the front-rear direction, but in reality the ducts 11 to 13 are arranged in the width or right-left direction as shown in FIG. 2.

Equipment spaces 14 and 15 are formed in the roof 2u and the base 2d of the case 2 of the storage apparatus 1. A heater 17 for heating that generates high-temperature conditioning air A2, and a circulating fan 16, which supplies air that has been sucked in from the storage space 3 via the non-shelf discharge duct 13 after heating to the storage space 3 via the non-shelf supply duct 12, are disposed in the equipment space 14 in the roof 2u. A heat exchanger 19 for cooling that generates low-temperature conditioning air A1, and a circulating fan 18, which supplies air that has been sucked in from the storage space 3 via the non-shelf discharge duct 13 after cooling to the storage space 3 via the non-shelf supply duct 11, are disposed in the equipment space 15 of the base 2d. In addition, a humidifier 39 is disposed in the equipment space 15 for cooling so that humidity can also be adjusted. The equipment for heating in the equipment space 14 and the equipment for cooling in the equipment space 15 are controlled by a control apparatus 20, so that the conditioning air A2 and A1 that have been controlled so as to be predetermined temperatures are supplied from the respective equipment spaces 14 and 15 to the respective supply ducts 11 and 12.

In the first out-of-shelf supply duct 11 that supplies the low-temperature air A1, a plurality of supply ports (connection ports on the supply duct side) 21 that are connections for the display shelves 10 and supply the low-temperature air A1 to the display shelves 10 are formed at an appropriate pitch in the up-down direction. Also, in the second out-of-shelf supply duct 12 that supplies the high-temperature air A2, a plurality of supply ports (connection ports on the supply duct side) 22 that are connections for the display shelves 10 and supply the high-temperature air A2 to the display shelves 10 are formed at fixed intervals in the up-down direction. In the out-of-shelf discharge duct 13 for outlet, a plurality of recovery ports (connection ports on the discharge duct side) 23 that are connections for the display shelves 10 and discharge air via the display shelves 10 are formed at fixed intervals in the up-down direction. These supply ports 21, 22 and recovery ports 23 are designed so as to be linearly aligned and to not coincide in a horizontal direction for the rear surface 2b of the case 2, that is, the left-right direction W when looking from the front surface 2a of the housing 2. This means that connection regions 28, in each of which the supply openings 21, 22 and a recovery opening 23 are aligned in the left-right direction, are disposed at fixed intervals in the up-down direction on the rear surface 2b of the case 2.

In the storage apparatus 1, by attaching the shelf 10 to any of the connection regions 28, one of the low-temperature air A1 and the high-temperature air A2 or a mix of the two according to desired conditions can be supplied via the shelf 10, with it also being possible to discharge the air from the zone 4. The respective display shelves 10 can be detachably attached to freely chosen connection regions 28 on the rear surface of the housing 2 by engaging hooks 10a that protrude from the rear surfaces of the shelves 10 as a means for attachment/detachment to/from attachment holes 21a and 22a that are provided in the rear surface 2b of the case 2.

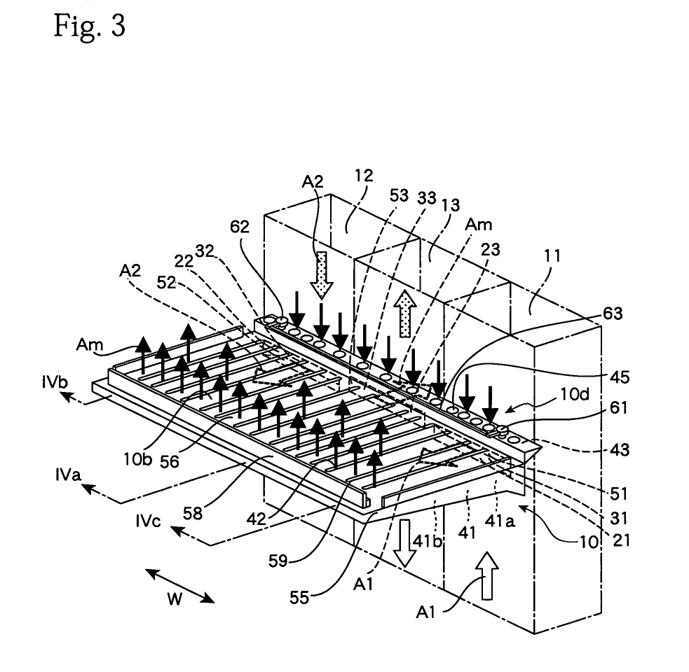

FIG. 3 is a perspective view showing the appearance of a display shelf 10. The display shelf 10 is provided with a cold air intake port (first connection port on the shelf) 31 that is connected to the supply port 21 of the cold air supply duct 11, a hot air intake port (second connection port on the shelf 32 that is connected to the supply port 22 of the hot air supply duct 12, and an internal supply duct (shelf supply duct) 41 for blowing out air supplied from the intake ports 31 and 32 through inside the display shelf 10. The internal supply duct 41 incorporated in the shelf 41 is connected to a plurality of air outlets 42 provided in the surface 10b of the display shelf 10. The plurality of air outlets 42 are formed so as to be distributed across substantially the entire surface 10b of the display shelf 10. Though the internal supply duct 41, the selected or mixed air Am is blown out upwards from the plurality of air outlets and the air outlets are disposed below the products in the region of the surface of the display shelf 10 in which the products are disposed. Accordingly, on the display shelf 10, the conditioning air Am, which has been set by desired conditions, is blown out so as to contact the products disposed on the shelf 10 almost immediately, so that the products disposed on the display shelf 10 are efficiently covered by the air Am and the environmental conditions are maintained. The air outlets 42 of the shelf surface 10b may be holes or may be slits.

The display shelf 10 includes an discharge port (third connection port on the shelf) 33 that connects to a recovery port 23 in the out-of-shelf discharge duct 13 and an internal discharge duct (shelf discharge duct) 43 that exhausts the air Am sucked in from the zone 4 to the discharge port 33, with a plurality of suction holes 45 for sucking in air from the zone 4 being provided in the surface of the duct 43. The internal discharge duct 43 extends in the left-right direction W along the base side 10d of the shelf 10. The plurality of suction holes 45 are disposed in the left-right direction across the base side 10d of the shelf 10 for making a substantially uniform flow of the mixed conditioning air Am in the left-right direction W above the shelf 10, in the air flow, the mixed conditioning air Am is distributed from the surface 10b of the display shelf 10, blown around the products and sucked in from the base end side 10d of the same display shelf 10 and discharged

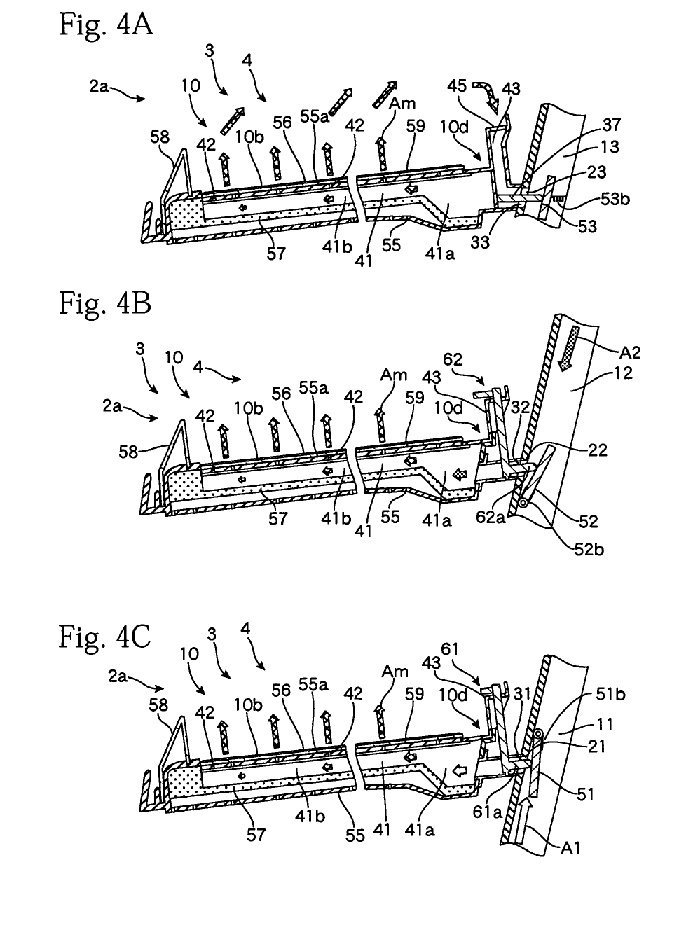

FIG. 4 is a cross-sectional view showing the internal arrangement of the display shelf 10. FIG. 4A is a cross-sectional view of a substantially central position of the shelf 10, with a discharge port 33 positioned in the center of the base end 10d being visible. FIG. 4B is a cross-sectional view of the left side of the shelf 10 looking from the front 2a of the case 2 (unless noted otherwise in the present specification, the direction looking from the front 2a is shown), with the hot air intake port 32 positioned on the left of the base end 10d being visible. FIG. 4C is a cross-sectional view of the right side of a shelf 10, with the cold air intake port 31 positioned on the right of the base end 10d being visible. The hot air intake port 32, the discharge port 33, and the cold air intake port 31 are arranged on the base end 10d so as to be aligned in that order in the left-right direction W, and are located corresponding to the connection ports 22, 23, and 21 of the connection regions 28 in the rear surface 2b of the case 2.

Dampers 51, 52, and 53 are disposed on the supply ports 21 of the cold air supply duct 11, the supply ports 22 of the hot air supply duct 12, and the recovery ports 23 of the discharge duct 13, and when a shelf 10 is not attached, that is when the shelf 10 is removed, the supply ports 21, 22 and the recovery ports 23 are respectively closed by the dampers 51, 52, and 53 due to the springs 51b, 52b, and 53b, so that the supplying and discharging of air is not carried out. On the other hand, when a shelf 10 is attached, operation pins 61a, 62a, and 37 that protrude from the shelf 10 push open these dampers 51, 52 and 53, so that a supply port 21 of the cold air supply duct 11 is connected to the cold air intake port 31, a supply port 22 of the hot air supply duct 12 is connected to the hot air intake port 32, and a recovery port 23 of the discharge duct 13 is connected to the discharge port 33. Conditioning air Am therefore circulates in the storage space 3 via the shelf 10.

The protruding amounts of the operation pins 61a and 62a that operate the dampers 51 and 52 that are respectively disposed on the supply ports 21 and 22 are controlled by damper opening control levers 61 and 62 provided on the shelf 10. By doing so, the opening (i.e., opened amount or opening degree) of the respective dampers 51 and 52 can be controlled, and since the opening of the cold air intake port 31 and the hot air intake port 32 of the shelf 10 are therefore controlled, the amounts of cold air A1 and hot air A2 supplied to the shelf 10 can be controlled, so that the both air are mixed inside the shelf 10 and the temperature of the conditioning air Am blown out from the surface of the shelf 10 can be adjusted. Accordingly, in the shelf 10 according to the present embodiment, the damper opening control levers 61 and 62 and the operation pins 61a and 62a operated thereby correspond to an opening adjusting means, and by controlling the dampers 51 and 52 on the supply duct side, the degree of opening between the cold air intake port 31 of the shelf 10 and the cold air supply duct 11 and the degree of opening between the hot air intake port 32 of the shelf 10 and the hot air supply duct 12 are controlled respectively.

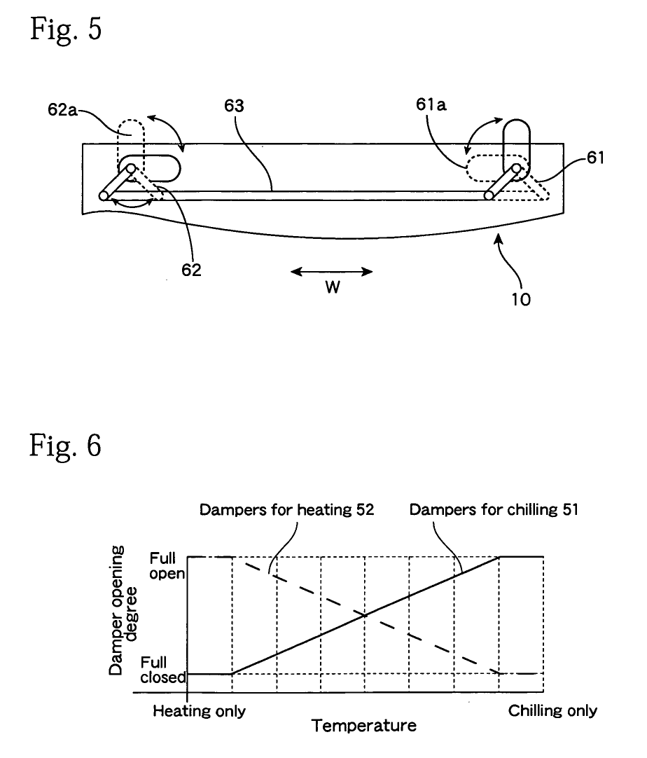

The damper opening control levers 61 and 62 control the degrees of openings connections to the respective ducts 11 and 12, and by independently operating these levers, the conditions of the conditioning air Am blown out from the shelf 10 can be flexibly controlled. On the other hand, it becomes difficult to make the air flow blown out from the shelf 10 constant. To make the amount of conditioning air Am blown out from the respective shelves 10 substantially constant, it is preferable to control the total opening of the dampers 51 and 52 so as to be constant. To do so, it is preferable to adjust the respective openings of the dampers 51 and 52 synchronously or cooperatively. In FIG. 5, the operation levers 61 and 62 are connected by a rod 63 so that the opening of both dampers can be controlled by operating a single operation lever. In FIG. 5, in the state shown by the broken lines, the operation pin 62a protrudes so that the damper 52 that controls the opening of the hot air intake port 32 is completely open and the operation pin 61a does not protrude so that the damper 51 that controls the opening of the cold air intake port 31 is completely closed. Accordingly, the state shown at the left end of FIG. 6 is achieved, where only the hot air A2 is supplied to the shelf 10, thereby producing a state suited to heating the product.

On the other hand, in the state shown by the solid lines in FIG. 5, the operation pin 62a does not protrude so that the damper 52 that controls the opening of the hot air intake port 32 is completely closed and the operation pin 61a protrudes so that the damper 51 that controls the opening of the cold air intake port 31 is completely open. Accordingly, the state shown at the right end of FIG. 6 is achieved, where only the cold air A1 is supplied to the shelf 10, thereby producing a state suited to chilling the product. By operating one of the operation levers 61 and 62, both the operation levers 61 and 62 move cooperatively, and the openings of the dampers 52 and 51 can be continuously controlled from a state where only the hot air A2 is supplied to the shelf 10, via intermediate states where both the hot air A2 and the cold air A1 are supplied, to a state where only the cold air A1 is supplied to the shelf 10. Suitable amounts of the hot air A2 and the cold air A1 for producing conditioning air Am of a suitable temperature can be supplied to the shelf 10 in a range from the “heating” state at the left end of FIG. 6 to the “chilling” state at the right end, with the air being mixed inside the shelf 10 and blown out from the surface 10b. Various methods can be used to control the protruding amount of the operation pins. The operation pins can be, instead of rotating as in the present embodiment, slid in the front-rear direction.

As shown by the various cross-sectional views in FIG. 4, the internal supply duct 41 that mixes the cold air A1 and the hot air A2 supplied to the shelf 10 and blows out the mixed air from the surface 10b of the shelf 10 includes a mixing part 41a that extends in the left-right direction on the base end side 10d of the shelf 10 and a supply part 41b that extends from the mixing part 41a toward the front. The supply part 41b is connected to a plurality of air outlets 42 provided in the surface 10b of the shelf 10 and blows out the mixed conditioning air Am. The mixing part 41a is connected to the cold air intake port 31 and the hot air intake port 32 and mixes the cold air A1 supplied to the shelf 10 from the cold air supply duct 11 outside the shelf and the hot air A2 supplied to the shelf 10 from the hot air supply duct 12 outside the shelf. The cross-sectional area (volume) of the mixing part 41a is made sufficiently large relative to the cross-sectional area (volume) of the supply part 41b. Accordingly, the differential pressure at the part where the mixing part 41a branches into the supply part 41b becomes large, so that the flow velocity in the mixing part 41a is sufficiently low and air Am is supplied to the supply part 41b after sufficiently mixing the cold air A1 and the hot air A2 inside the mixing part 41a. That is, in the shelf 10, the mixing part 41a functions as an air chamber or mixing space, and the air Am, which is produced by sufficiently mixing the two types of air A1 and A2 and is substantially uniform, is outputted from the shelf 10. As a result, air Am of substantially constant temperature is blown out from the entire surface 10b of the shelf 10 so that the environment of the zone 4 above the shelf 10 can be kept constant in a uniform state. In addition, the air Am blown out from the surface 10b of the shelf 10 is recovered by the discharge duct 43 positioned on the base 10d side of the shelf 10, so that the air Am whose conditions such as temperature and humidity have been set at desired states circulates in the zone 4 above the shelf 10 and the products displayed on the shelf 10 are kept in the desired environment. The discharge port 33 of the discharge duct 43 of the shelf 10 is disposed between the hot air intake port 32 and the cold air intake port 31 and is positioned at substantially the middle of the discharge duct 43. This means that the air Am can be recovered uniformly from the left and right of the zone 4, which also makes it possible to make the state of the entire zone 4 uniform.

By disposing the mixing part 41a whose cross-sectional area is large in the base end 10d of the shelf 10, the overall shape of the shelf 10 is designed so as to be tapered in cross-section with the front end being thin and the base end 10d being thick. The base end side 10d of the shelf 10 is the part where the shelf 10 is attached to the out-of-shelf ducts 11, 12, and 13 or the rear surface 2b of the case 2, and by making this end sufficiently thick, the strength of the shelf 10 is improved and it becomes possible to display a sufficient weight of products. In addition, by disposing the shelf discharge duct 43 along the base end 10d of the shelf 10, it is possible to further increase the thickness of the base 10d of the display shelf 10, and the strength of the shelf 10 can be increased further.

As shown in FIG. 4, the display shelf 10 includes a shelf main body 55 that is substantially concave and a shelf plate 56 that is attached so as to cover a cavity 55a of the shelf main body 55. Using the space surrounded by the shelf main body 55 and the shelf plate 56, the internal supply duct 41 is arranged. Insulation material 57 for preventing condensation is disposed in this space to divide the space into upper and lower parts. The upper part of these spaces that is divided by the insulation material 57 and surrounded by the insulation material 57 and the shelf plate 56 is corresponding to the internal supply duct 41 that includes the mixing part 41a and the supply part 41b. The plurality of air outlets 42 are formed on the shelf plate 56 and, from the air outlets 42, the air Am produced in the shelf supply duct 41 is supplied to the products. A lattice or lattice-like plate 59 made of resin is placed on the shelf plate 56. By using a fluororesin with a low friction coefficient or the like as the lattice-like plate 59, it is possible to facilitate the sliding of products, such as canned drinks, on the display shelf 10. The lattice 59 functions so as to provide a certain amount of gap between products such as canned drinks and the air outlets 42 so that the supplying of the air Am is not blocked by the products. A toppling preventing plate 58 that prevents products from toppling is provided at the front of the shelf main body 55.

In this storage apparatus 1, two types of conditioning air A1 and A2 with different conditions are supplied via a display shelf 10 from the out-of-shelf supply ducts 11 and 12 to the storage space 3. By providing the damper control mechanisms 61 and 62 on a shelf 10, the shelf 10 can be used as a means of adjusting the flow of the conditioning air A1 and A2. In addition, since the conditioning air A1 and A2 are mixed and outputted by the shelf 10, the shelf 10 is also used as a chamber. More over, the shelves 10 are means for displaying products and the storage space 3 is divided by the display shelves 10 into spaces for the products to be displayed. In the storage apparatus 1 according to the present invention, a plurality of types of conditioning air is supplied via the shelves 10, the supplied amounts and mixed proportions of the plurality of types of conditioning air can be changed for each shelf on which products are displayed, and the plurality of types of conditioning air can be mixed and supplied on a shelf-by-shelf basis. Therefore, in the storage apparatus 1, for the ducts 11 and 12 that supply the conditioning air and the housing or case 2 that form the storage space, it is not necessary to provide mechanisms for controlling the supplied amounts of the plurality of types of conditioning air or means for mixing the plurality of types of conditioning air, so that the construction of the out-of-shelf parts are simplified and a highly reliable storage apparatus can be provided at low cost.

The shelves 10 of the present embodiment have a mechanism that controls the amounts of the plurality of types of conditioning air and a mechanism that mixes and outputs the plurality of types of conditioning air, so that the construction of the shelves 10 becomes complex. The shelves 10 are easily attached to and detached from the case 2, so that maintenance of the shelves 10 can be performed easily and each shelves can be replaced when some problem may occur. By mounting mechanisms that control the amounts of conditioning air and mechanisms that mix and output the conditioning air on the shelves 10 themselves that partition the storage space, it is possible to minimize the number of mechanisms for controlling the conditioning air and mechanisms for mixing and outputting the conditioning air, so that redundant control mechanisms and ducts can be omitted. This means that it is possible to provide, at low cost, a storage apparatus with a function for freely forming different temperature regions within a storage space, or in other words, for freely displaying products in different temperature regions in the storage space. The conditions of the various types of conditioning air include not only temperature but humidity, fragrance, or the like. In this storage apparatus, using the conditioning air, not only a variety of environments that are suited to storage of the displayed products but also an environment that fit the user and/or seasonal request and arouse consumer interest, it is possible to provide an extremely convenient storage apparatus 1 wherein the product can be flexibly displayed.

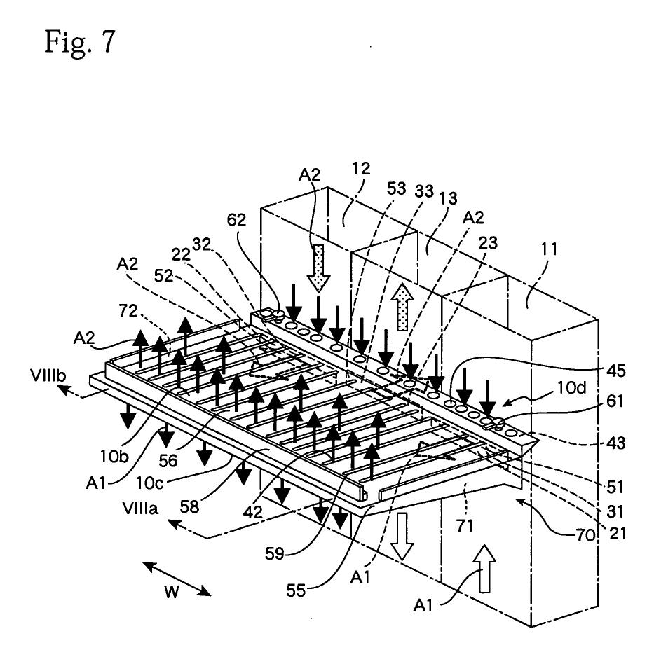

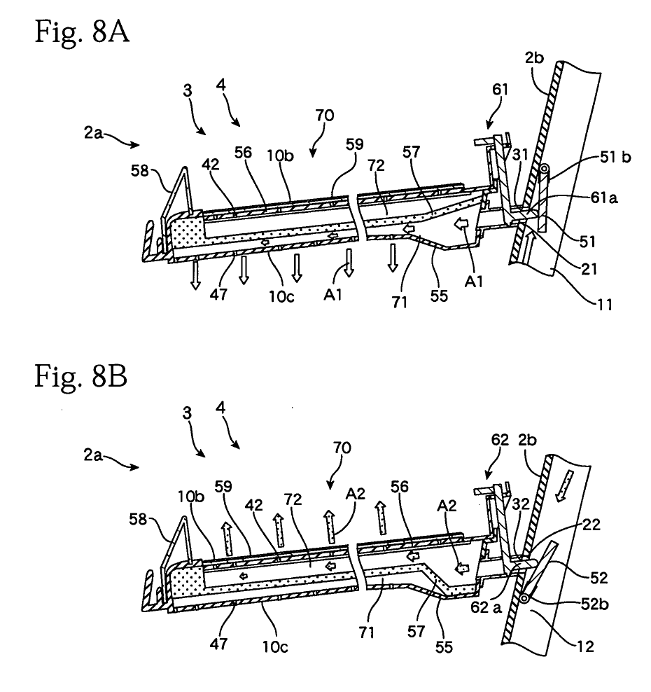

Although the display shelf 10 described above mixes two types of conditioning air A1 and A2 with different conditions and blows the mixture out to a zone 4 from the surface 10b, it is also possible to use a construction where two types of conditioning air with different conditions are independently blown out from the surface 10b and the rear surface 10c. FIG. 7 is a perspective view showing a display shelf 70 that blows out the cold air A1 from a lower surface and blows out the hot air A2 from the upper surface. FIG. 8 is two cross-sectional views of the display shelf 70. FIG. 8A shows a cross section of a right side of the display shelf 70 that includes the connection port 31 through which the cold air A1 is supplied. FIG. 8B shows a cross section of a left side of the display shelf 70 that includes the connection port 32 through which the hot air A2 is supplied. Parts that are common to the display shelf 10 described above have been assigned the same numerals.

An internal space of the display shelf 70 is divided in the up-down direction by the insulation material 57 for preventing condensation, and so includes a supply duct (a second shelf supply duct) 71 for blowing out the cold air A1 from the rear surface 10c of the display shelf 70 and a supply duct (a first shelf supply duct) 72 for blowing out the hot air A2 from the upper surface 10b of the display shelf 70. As shown in FIG. 8A, the cold air A1 supplied from the cold air supply port 31 is supplied via the lower internal supply duct 71 to the products below from air outlets 47 provided on the rear surface 10c, so that products displayed in the zone 4 below the shelf 70 can be chilled. On the other hand, the hot air A2 supplied from the hot air supply opening 32 is supplied via the upper internal supply duct 72 to the products above from air outlets 42 provided on the upper surface 10b, so that products displayed in the zone 4 above the shelf 70 can be heated. It is possible to separate a heated zone and a chilled zone that are adjacent above and below with a shelf 10 that avoids a redundant zone where the cold air A1 and the hot air A2 are mixing and products cannot be displayed.

By providing recovery ports connected to the discharge duct 13 in the rear surface 2b of the case 2 in a storage apparatus for this display shelf 70, the hot air A2 is circulated in the zone above the shelf plate 70 and the cold air A1 is circulated in the zone below the shelf plate 70.

In the shelf 10 that supplies conditioning air (the hot air A2 and the cold air A1) and recovers air, the operation pins 61a, 62a and 37 that operate the dampers 51, 52, and 53 respectively are provided on the duct connecting part of the shelf 10 so that pins connect the cold air supply duct 11, the hot air supply duct 12, and the recovery duct 13 with the supply duct 41 and discharge duct 43 respectively and control the openings of the connections respectively. It is possible to use a suitable link mechanism, such as a rod, that moves not just the operation pins 61a, 62a but also the operation pin 37 at the recovery position cooperatively. By operating one of the operation levers or a common operating part, the three operation pins can be simultaneously moved cooperatively so that the shelf can be used in a variety of conditions, such as when switching between chilling and heating, continuously changing the supply proportions of the cold air and hot air, or completely closing the openings and using the shelf simply as a display shelf. A link mechanism that operates the operation pin 61a for cold air and the operation pin 62a for hot air so as to selectively protrude into the cold air supply duct 11 and the hot air supply duct 12 is also applicable. In this case, the operation pin 37 for recovery port protrudes in either state. By providing a link mechanism that has a normal temperature mode that is a middle position between chilling and heating, where neither damper opens for displaying a normal temperature condition. In a storage apparatus where the shelf 10 is fixed to the case 2, dampers can be provided inside the shelf 10 and the opening of such dampers are adjusted. In this case, the dampers themselves are the opening adjusting means.

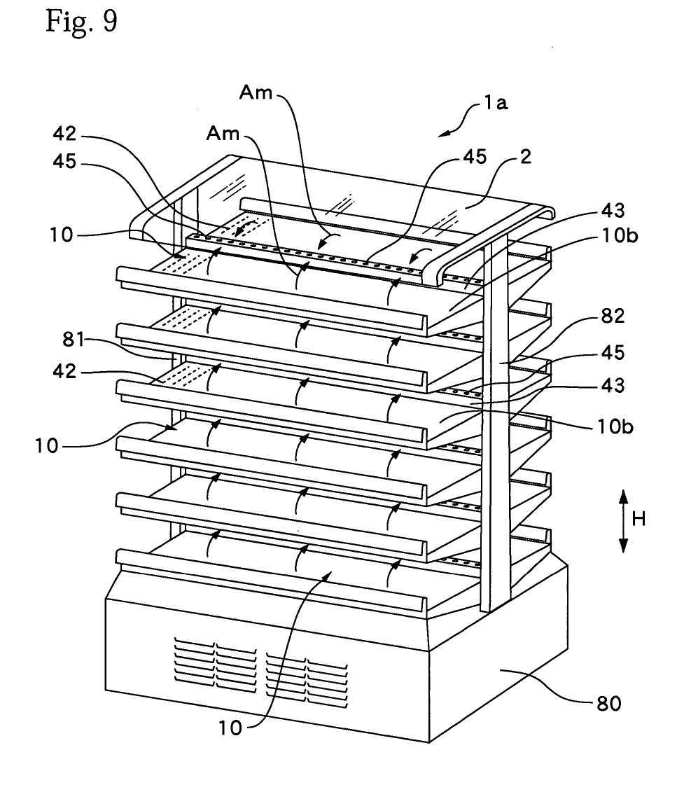

FIG. 9 is a perspective view of a different storage apparatus 1a according to the present invention. Parts that are common to the storage apparatus 1 described above have been assigned the same numerals. The storage apparatus 1 is a type where shelves 10 are set inside the housing that constructs the storage space 3, but the storage apparatus 1a is a showcase where the display shelves 10 are supported by two posts 81 and 82 erected from a base 80, but does not have an equivalent to the housing of the storage apparatus 1 described above and is a showcase that is open on four sides. The two supports 81 and 82 function as ducts in addition to mechanically supporting the display shelves. As one example, the support 82 includes two out-of-shelf supply ducts and the other support 81 includes the out-of-shelf discharge duct. In the other example, the support 82 includes three ducts, in yet the other example, the supports respectively include the supply ducts that supply air with different conditions. In the storage apparatus 1a, the display shelves 10 are attached not to the housing but to the supports 81 and 82 that function also as ducts, with the base end sides of the display shelves 10 being the sides of the support 81 and 82. In the storage apparatus 1a, heat exchangers, fans, and the like are disposed inside the base 80, and cold air and hot air generated inside the base 80 are supplied to the respective display shelves 10 from two out-of-shelf supply ducts in one of the supports 82. The air is then mixed inside each shelf and is supplied to products from a plurality of air outlets 42 in the surface 10b. The air Am blown out onto the products is sucked into the suction openings 45 of the discharge duct 43 that extends from one support 81 to the other support 82, and is recovered to the base 80 via a out-of-shelf discharge duct in the other support 82.

1. A storage apparatus comprising:
a shelf for displaying products;
a first out-of-shelf supply duct that, for controlling environmental conditions in a periphery of the products, supplies first conditioning air adjusted to a first condition; and
a second out-of-shelf supply duct that supplies second conditioning air adjusted to a second condition that differs to the first condition,
wherein the shelf comprises:
a first connection port that is connected to the first out-of-shelf supply duct;
a second connection port that is connected to the second out-of-shelf supply duct;
an opening adjusting means for adjusting an opening of the first connection port to the first out-of-shelf supply duct and an opening of the second connection port to the second out-of-shelf supply duct, respectively; and
a shelf supply duct for blowing out at least one of the first conditioning air supplied from the first connection port and the second conditioning air supplied from the second connection port from air outlets disposed at least one of above and below the shelf,
wherein in the shelf supply duct, the first conditioning air supplied from the first connection port and the second conditioning air supplied from the second connection port are mixed.

2. (canceled)

3. A storage apparatus according to claim 1,
wherein the first connection port and the second connection port are disposed so as to not coincide in a left-right direction of the shelf, and
the shelf supply duct includes a mixing part that extends in the left-right direction of the shelf so as to connect the first connection port and the second connection port, and a supply part that extends from the mixing part in a front-rear direction of the shelf, the supply part being connected to the air outlets and a cross-sectional area of the supply part being smaller than that of the mixing part.

4. A storage apparatus according to claim 3,
wherein the first connection port, the second connection port, and the mixing part are disposed on a base end side of the shelf, and
the base end side is a side where the shelf is attached to at least one of the first out-of-shelf supply duct, the second out-of-shelf supply duct, and a housing that forms a storage space in which the shelf is disposed.

5. A storage apparatus according to claim 1,
further comprising an out-of-shelf discharge duct disposed in parallel with the first out-of-shelf supply duct and the second out-of-shelf supply duct,
wherein the shelf further comprises a shelf discharge duct that extends in a left-right direction and a third connection port that connects the shelf discharge duct to the out-of-shelf discharge duct.

6. A storage apparatus according to claim 5,
wherein the first connection port, the second connection port, and the third connection port are disposed in a line in the left-right direction on a base end side of the shelf, and
the base end side is a side where the shelf is attached to at least one of the first out-of-shelf supply duct, the second out-of-shelf supply duct, and a housing that forms a storage space in which the shelf is disposed.

7. A storage apparatus according to claim 6,
wherein the first connection port and the second connection port are disposed so as to not coincide in the left-right direction of the shelf and the third connection port is disposed between the first connection port and the second connection port.

8. A storage apparatus according to claim 5,
wherein the shelf discharge duct is disposed on a base end side of the shelf, and
the base end side is a side where the shelf is attached to at least one of the first out-of-shelf supply duct, the second out-of-shelf supply duct, and a housing that forms a storage space in which the shelf is disposed.

9. A storage apparatus according to claim 1,
wherein the shelf further comprises a means for detachably attaching to at least one of the first out-of-shelf supply duct, the second out-of-shelf supply duct, and a housing that forms a storage space in which the shelf is disposed.

10. A storage apparatus according to claim 9,
wherein duct-side connection ports of the first out-of-shelf supply duct and the second out-of-shelf supply duct that are respectively connected to the first connection port and the second connection port include dampers that automatically close when the shelf is detached.

11. A storage apparatus according to claim 10,
wherein openings of the dampers are adjustable by the opening adjusting means of the shelf.

12. A storage apparatus according to claim 1,
wherein the shelf supply duct includes a first supply duct that outputs one of the first conditioning air supplied from the first connection port and the second conditioning air supplied from the second connection port from an upper surface of the shelf and a second supply duct that supplies an other of the first conditioning air and the second conditioning air from a lower surface of the shelf.

13. A storage apparatus according to claim 1,
wherein the shelf supply duct is enclosed inside the shelf.

14. A shelf for displaying products, comprising:
a first connection port that is connected to a first out-of-shelf supply duct that, for controlling environmental conditions in a periphery of the products, supplies first conditioning air adjusted to a first condition;
a second connection port that is connected to a second out-of-shelf supply duct that supplies second conditioning air adjusted to a second condition that differs to the first condition;
an opening adjusting means that adjusts an opening of the first connection port to the first out-of-shelf supply duct and an opening of the second connection port to the second out-of-shelf supply duct, respectively; and
a shelf supply duct for blowing out at least one of the first conditioning air supplied from the first connection port and the second conditioning air supplied from the second connection port from air outlets disposed at least one of above and below the shelf,
wherein the shelf supply duct mixes and blows out the first conditioning air supplied from the first connection port and the second conditioning air supplied from the second connection port.

15. (canceled)

16. A shelf according to claim 14,
wherein the first connection port and the second connection pod: are disposed so as to not coincide in a left-right direction of the shelf, and
the shelf supply duct includes a mixing part that extends in the left-right direction of the shelf so as to connect the first connection port and the second connection port, and a supply part that extends from the mixing part in a front-rear direction of the shelf, the supply part being connected to the air outlets and a cross-sectional area of the supply part being smaller than that of the mixing part.

17. A shelf according to claim 16,
wherein the first connection port, the second connection port, and the mixing part are disposed on a base end side of the shelf, and
the base end side is a side where the shelf is attached to at least one of the first out-of-shelf supply duct, the second out-of-shelf supply duct, and a housing that forms a storage space in which the shelf is disposed.

18. A shelf according to claim 14, further comprising:
a shelf discharge duct; and
a third connection port that connects the shelf discharge duct to an out-of-shelf discharge duct.

19. A shelf according to claim 18,
wherein the shelf discharge duct is disposed on a base end side of the shelf, and
the base end side is a side where the shelf is attached to at least one of the 25 first out-of-shelf supply duct, the second out-of-shelf supply duct, and a housing that forms a storage space in which the shelf is disposed.
